(19) United States
(12) Patent Application Publication
(10) Pub. No.: US 2008/0086879 A1
(43) Pub. Date: Apr. 17, 2008

(54) Method, Computer Software Code, and System for Restoration of Piston Pins and Articulating Pins

(76) Inventors: Alistair Jeffrey Smith, Simpsonville, SC (US); Wayne Alan Demo, Maineville, OH (US); Stephen Joseph Ferrigno, Cincinnati, OH (US); Brian Robert Graham, Cincinnati, OH (US); Jeffrey Stanley Keller, Cincinnati, OH (US); William Brooks, Lebanon, OH (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/537,689

(22) Filed: Oct. 2, 2006

(51) Int. Cl. B23P 6/00; G06F 9/44; B23P 19/04

(52) U.S. Cl. 29/888.041; 29/402.04; 29/402.05; 29/402.09; 29/402.11; 29/402.18; 29/407.01; 717/100

(57) ABSTRACT

A method for restoring a piston pin and/or an articulating pin after operating in an engine, the method includes removing material from the pin so that the pin has a concentric shape, conditioning the pin to accept application of a new material, and plating the outer diameter of the pin so as to restore the pin to near original dimensions.

### FIELD OF INVENTION

The field of invention relates to locomotive engines and, more particularly, to a method, computer software code, and system for refurbishing parts of the locomotive engine.

### BRIEF DESCRIPTION OF THE INVENTION

A locomotive is a railway vehicle that provides the motive power for a train. It usually does not have a payload capacity of its own, but instead its sole purpose is to move railway rolling stock along the tracks. One type of engine used to drive the locomotive is a diesel-electric engine. Examples of such engines include, but are not limited to, high compression, four-stroke turbo-diesel engines with 8-cylinders, 12-cylinders, or 16-cylinders.

These engines include such elements as turbochargers, welded head-liner assemblies, high-strength pistons, solid engine blocks, and heavy-duty crankshafts. In an exemplary embodiment, the turbocharger is a single free-spinning, exhaust-driven turbocharger that provides air to the cylinders at approximately four times atmospheric pressure. Since trains travel through tunnels where the conditions result in temperatures as high as 150 degrees Fahrenheit (F) (65.5 Celsius (C)), these turbochargers are designed to cool in such conditions. In another exemplary embodiment, twin turbochargers are utilized with an electronically fuel-injected engine. The pistons have forged steel crowns so as to effectively resist high stress and heat conditions. The piston crown is bolted to aluminum-alloy skirts for lighter weight and increased material recover in overhauls. The pistons use two rings for compression and a third ring for oil control. The exemplary engine block is made of a single piece of sturdy cast iron. Oil passages are cast into the frame to reduce potential leaks. No cooling water, intake air or exhaust gases touch the frame. The one-piece camshaft is forged from high-quality steel and nitride-hardened for long life.

Another part of the engine is the master rods and the articulating rods. One rod is fixed, and it is generally known as the master rod. The others are called articulating rods and are attached to the master rod using articulating pins. The master rods and articulating rods are attached to the pistons by way of piston pins. The rods mount on pins that allow them to rotate as the crankshaft and the pistons move. The articulating pins are located in a saddle area and are bolted to the rods. This joint then allows the articulating rods to pivot on the master rod, and for the piston to pivot on the master and articulating rods.

No matter how well any engine is constructed, over time and use, parts will require replacing, and/or remanufacturing. Even though newer engines are developed over time which may be more efficient than currently used engines, locomotive companies realize a financial savings when cost effective techniques and parts are available to refurbish existing engines rather than having to replace an engine. For example, the bolted joint between the pins and the rods during engine operations imparts fretting onto the pins and rods. During overhaul of the engine this fretting need to be removed. Fretting is refers to corrosion damage at the asperities of contact surfaces. This damage is induced under load and in the presence of repeated relative surface motion, as induced for example by moving and/or vibrating parts. Pits or grooves and oxide debris characterize this damage, typically found in machinery, bolted assemblies and ball or roller bearings. Currently, when an engine is being overhauled with respect to the piston pins and articulating pins, a process involves using a grind process to remove any fretting that may have accumulated. However, the fretting is usually confined to one specific area of the pin. Furthermore, once the fretting is removed the pin may not have enough material available on the pin to allow the pin to be used within the engine.

Locomotive owners would benefit from a method, computer software code, and system for refurbishing piston pins and articulating pins found in locomotive engines.

### BRIEF DESCRIPTION OF THE INVENTION

Embodiments of the invention provide for a method and system for refurbishing parts of a locomotive engine. Towards this end, an exemplary embodiment of a method for restoring a used piston pin and/or an articulating pin is disclosed. The method includes removing materials from the pin so that the pin has a concentric shape. The method also includes conditioning the pin to accept application of a new material, and plating the outer diameter of the pin so as to restore the pin to near original dimensions.

Another exemplary embodiment provides computer software code readable by a computer that configures the computer to manage the restoration of a used piston pin and/or an articulating pin is disclosed. The computer software code includes a computer module for operating an instrument for removing materials from the pin so that the pin has a concentric shape. A computer module for operating an instrument for conditioning the pin to accept application of a new material is also included. Also, a computer module for operating an instrument for plating the outer diameter of the pin so as to restore the pin to near original dimensions is included.

A system for restoring a used piston pin and/or a used articulating pin is disclosed in another exemplary embodiment. The system includes a length determining device for determining a diameter of the rod. A conditioning device for removing undesired material and/or providing the pin with a concentric shape is also provided. A plating device for fixing a second material to the pin is provided, wherein the pin with the fixed material restores the pin to an acceptable diameter for use within the engine.

In another exemplary embodiment a pin for use as a piston pin and/or an articulating pin that is used in an engine is disclosed. The pin includes an inner core made of a pin that has previously operated within the engine, and an outer cover applied to parts of the inner core that is able to within operating conditions of the engine.

In yet another exemplary embodiment, an engine having a piston pin and/or an articulating pin that accumulates fretting after operating in the engine so that the pin is no longer concentric and a method for restoring an outer circumference of the pin to a concentric shape is disclosed. The method includes locating an offset axis on the pin. The pin is rotated about the offset axis so that a fretted area rotates at a distance further away from the offset axis than the rest of the pin. The pin is rotated proximate a grinder so that only the fretted area contacts the grinder.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A depicts an exemplary embodiment of a cutaway section of an articulating pin;

FIG. 1B depicts an exemplary embodiment of a cutaway section of an articulating pin taken along line 1B-1B of FIG. 1A;

FIG. 1C depicts an exemplary embodiment of a cylindrical side of the articulating pin

FIG. 2A depicts an exemplary embodiment of a piston pin;

FIG. 2B depicts an exemplary embodiment of a piston pin taken along line 2B-2B of FIG. 2A;

FIG. 2C depicts an exemplary embodiment of a piston pin taken along line 2C-2C of FIG. 2B;

FIG. 2D depicts an exemplary embodiment of a cylindrical side of the articulating pin;

FIG. 3 depicts an exemplary embodiment of a method of the present invention;

FIG. 4 depicts an exemplary embodiment of elements that are used in a system of the present invention;

FIG. 5 depicts an exemplary embodiment of eccentric grinding; and

FIG. 6 depicts an exemplary embodiment of a top view of a pin illustrating where fretting may have occurred.

### DETAILED OF THE INVENTION

The present invention solves the problems in the art by providing a system, method, and computer implemented method for refurbishing parts of a locomotive engine. Towards this end, a system, method, and computer process is disclosed to restore used and/or fretted piston pins and/or articulating pins to acceptable dimensions. In an exemplary embodiment an eccentric grind process focuses the grinding on an area of the pin where fretting has occurred. In another exemplary embodiment, when not enough material remains on the pin after the fretting is removed, additional material is then added to the pin. The material added is machineable and durable enough to withstand engine operation as well as the material comprising the original pin. An electroless-Nickel plating process may be utilized to restore the pins to a usable condition.

Reference will now be made in detail to various embodiments of the invention, examples of which are illustrated in the accompanying drawings. Wherever possible, the same reference numerals used throughout the drawings refer to the same or like parts.

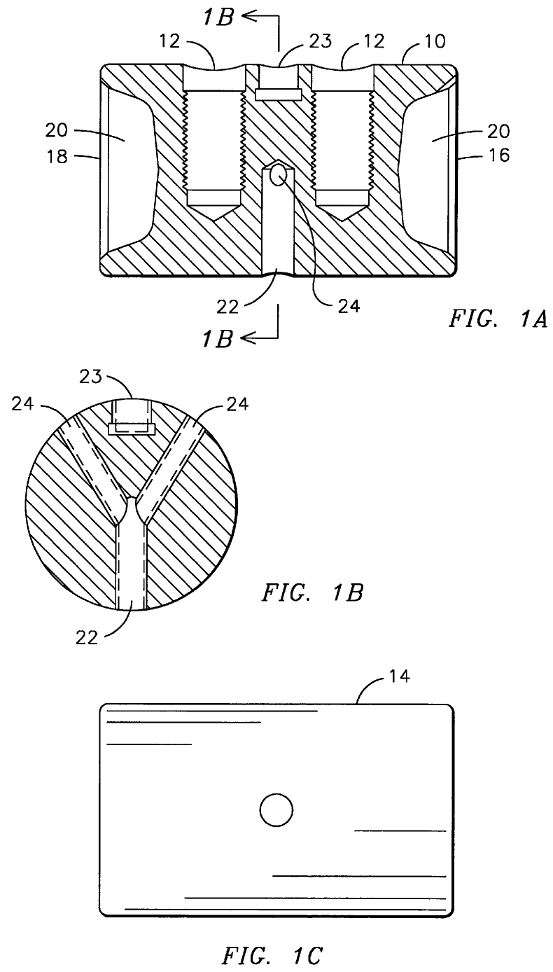

FIG. 1A depicts an exemplary embodiment of a cutaway section of an articulating pin, and FIG. 1B depicts an exemplary embodiment of a cutaway section of an articulating pin taken along line 1B-1B of FIG. 1A, and FIG. 1C depicts the cylindrical shape of the articulating pin. As illustrated, two bolt holes 12 are provided in the articulating pin 10. Bolts that fit within the bolt holes 12 are used to attach the pin 10 to a saddle area of an articulating rod. During normal engine operation, fretting occurs, on the outer diameter 14 of the pin 10, and in the joint between of the pin 10 and the articulating rod. On the left 16 and right 18 sides of the pin 10, a dimpled area 20 is provided. Also, an oil hole 22 and a dowel pin hole 23 are provided between the bolt holes at a center of the pin, between the bolt holes 12. Internally, two channels 24 extend from the oil hole near the endpoint of the oil hole to an outer surface 14 of the side of the pin 10.

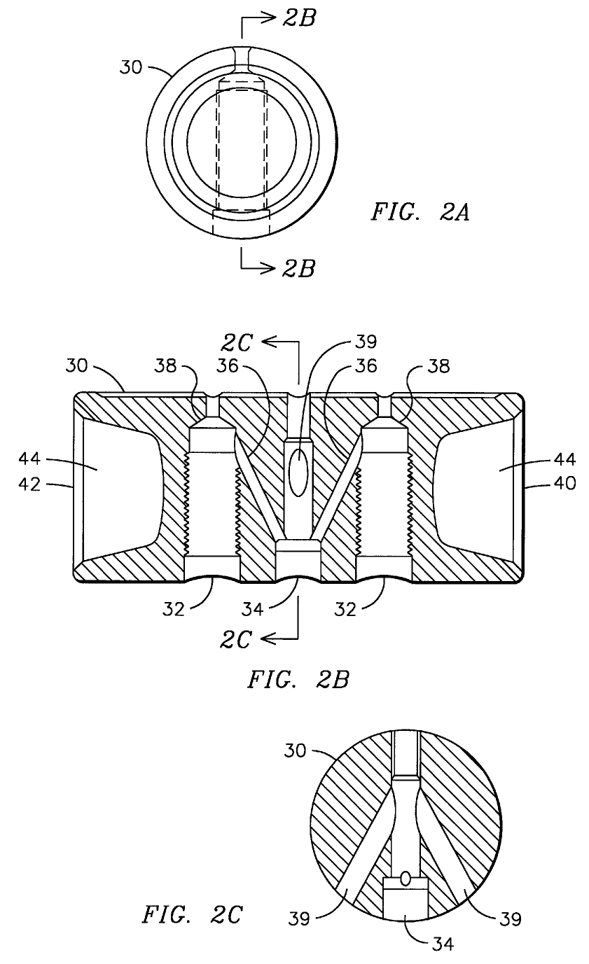

FIG. 2A depicts an exemplary embodiment of a piston pin, FIG. 2B depicts an exemplary embodiment of the piston pin taken along line 2B-2B of FIG. 2A, FIG. 2C depicts an exemplary embodiment of the piston pin taken along line 2C-2C of FIG. 2B, and FIG. 2D depicts a side of the piston pin. As illustrated, two bolt holes 32 are provided on the piston pin 30. An oil hole 34 is provided therethrough the pin 30, and between the bolt holes 32. The oil hole 34 has two channels 36 that extend from within the oil hole 34 and end at a tapered location 38 within the bolt holes 32. A second set of channels 39 extend from the oil hole 34 to an outer surface of the side 35 of the pin 30. On the left side 40 and right side 42 of the pin 30, a dimpled area 44 is provided

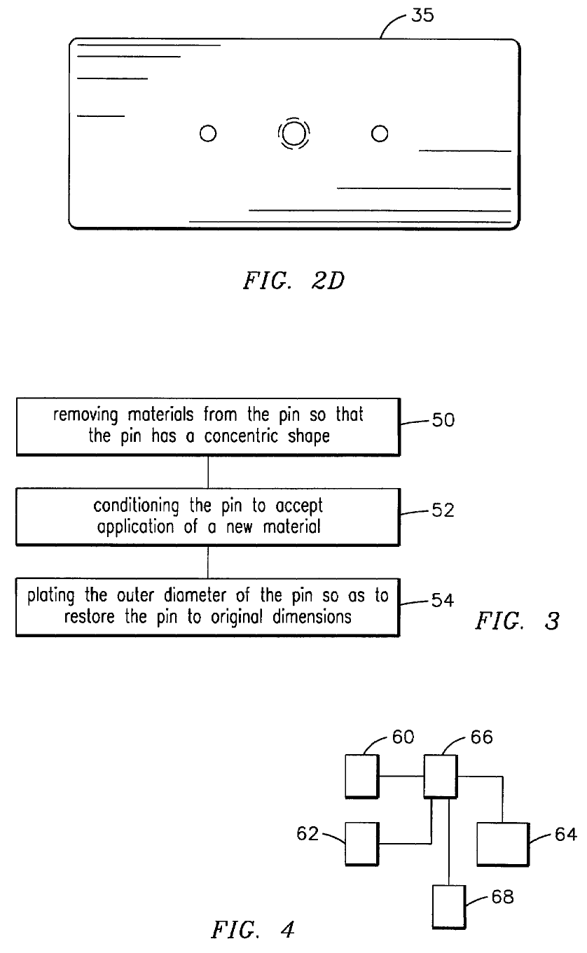

FIG. 3 depicts an exemplary embodiment of a method of the present invention. The method 51 provides a process or a computer controlled process for refurbishing a fretted articulating pin and/or a piston pin, such as used in a locomotive engine. As illustrated, fretting is removed so that the pin has a concentric shape, step 50. In an exemplary embodiment this is accomplished using an eccentric grinder to remove the fretting that has occurred on a specific side of the pin 10. Such fretting usually results in the outer diameter of the pin not being concentric. The pin is conditioned to accept application of a new material, step 52. Conditioning the pin may include, but is not limited to, vibratory honing the pin and stress relieving the pin. In an exemplary embodiment, stress relief is performed at approximately 325 degrees F, plus or minus 25 degrees (162.7 C, plus or minus 3.8 C), for at least approximately five hours. Plating is applied to the outer diameter of the pin so as to restore the pin to original dimensions, step 54. In an exemplary embodiment, electroless-Nickel plating is applied by placing the pin into a plating bath. After the plating is applied, the pin with the plating is baked, such as in a hydrogen bake at approximately 335 degrees F, plus or minus 25 degrees (168.3 C, plus or minus 3.8 C), for at least approximately twenty-four hours. In an exemplary embodiment, a second stress relieving test is applied after baking to provide structural integrity to the pin and coating. In an exemplary embodiment, if many pins are being refurbished simultaneously, a test sample amount of pins may go through the second stress test.

Preferably, if a pin has become corroded, prior to plating, plating should not be attempted until corrosion is removed. In an exemplary embodiment, the diameter desired for the plated pin should be equivalent to a new unused pin. For example, if a new pin has a diameter of 3.123 inches (7.932 centimeters (cm)) to 3.1225 inches (7.931 cm) when new, the plate-covered pin should have the same diameter. Additionally, as disclosed above, the pin may have additional holes, namely bolt holes, and/or dimples wherein plating is not required and/or desired. For example, platting is not needed in the bolt holes 12. Towards this end, a plug is inserted into such openings to insure that the plating material does not reach these surfaces. In an exemplary embodiment, the plugs are configured so as to insure that an outer edge of a hole is also not affected by the plating. For example, as illustrated in FIG. 2B, the plug may be designed to insure that approximately 1/32 of an inch (0.079 cm) at a chamfer leading into the opening that forms the oil hole is also covered. In an exemplary embodiment, the plating should not cover the radius of the bolt holes and/or oil holes and should not be within ⅛ of an inch (0.3175 cm) of these openings. Though a plug is disclosed, those skilled in the art will readily recognize that other covering embodiments may be utilized, such as a thermal tape. Those skilled in the art will readily recognize that the plug may be removed at any point after the platting process is completed.

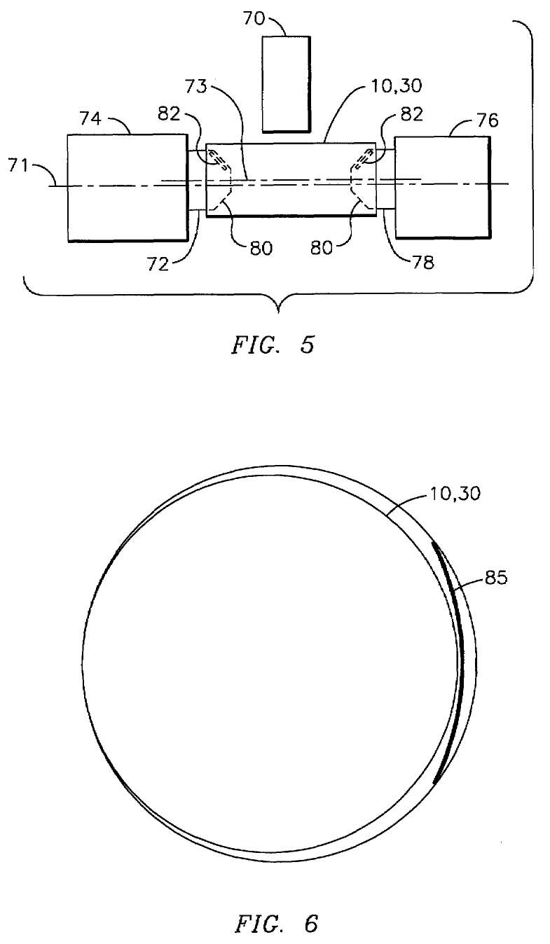

FIG. 5 depicts an exemplary embodiment of eccentric grinding the articulating pin and/or the piston pin. In an exemplary embodiment eccentric grinding the pin 10, 30 is held by the top and bottom 20, 44 of the pin 10, 30 at a location offset the center. Location an offset axis on the pin is determined. The offset location is determined based on where fretting has occurred on the pin 10, 30. Towards this end, the pin 10, 30 may be adjusted based on the machine center line 71 and the bull nose point centerline 73. More specifically, the pin 10, 30 is offset with respect to a grinder 70 based on the fretted area in reference to the balance of the pin diameter. Towards this end, an adjustable dead center 72, a piece of tooling that locates in the headstock 74, or driving head, of a machine is provided and transfers a rotational force to the pin 10, 30. The same attention is provided where the pin 10, 30 is held in place by a tailstock 76 with an adjustable livecenter 78. In an exemplary embodiment both centers of the pin 10, 30 have a modified bull nose point 80 with a drive key fitted 82. A new pin of known taper and concentricity is installed between the centers. Using adjusting screws and a dial indicator, indicating a distance the pin is moved, the pin 10, 30 is brought into a position where the taper and concentricity have been replicated.

Once the pin 10, 30 has been set-up concentrically and with a true offset the pin may be configured to remove additional fretting, such as in an exemplary embodiment, from the bolt hole area. In an exemplary embodiment, adjusting screws are used to move the pin bolt hole area, such as in an exemplary embodiment 0.0005 inches (0.00127 cm), closer to the grinding wheel. The adjusting screws are used to move the dead center 72 and livecenter 78. When off-setting the pin, care should be taken to insure that both centers are offset the same amount to maintain the parallelism of the pin during machining. Once completed, the set-up pin, or new pin, should be removed.

FIG. 6 depicts an exemplary embodiment of a top view of a pin illustrating where material may be removed. The pin 10, 30 is installed in a grinding apparatus and grinding takes place to achieve desired dimensions. As illustrated machining is directed to a saddle area 85, or saddle-wear area, of the pin 10, 30, which is an area where fretting has occurred. During machining, in an exemplary embodiment, the pin 10, 30 is rotated about the offset axis. Thus the fretted area rotates at a distance further away from the offset axis than the rest of the pin. So when grinding the pin 10, 30, only the fretted area contacts the grinder's grinding surface. In a preferred embodiment the bolt holes area are cut prior to any other area. Once grinding is completed, the pin 10, 30 should be inspected to insure proper concentricity and taper has been achieved.

FIG. 4 depicts an exemplary embodiment of elements that are used in a system of the present invention. A form of ruler, or length determining device, 60 is used to determine a diameter of the rod. The diameter disclosed herein is measured from one edge of the cylindrical surface, through the center point of the cylindrical top end, as illustrated in FIG. 2B and 3A, to a second edge of the cylindrical surface. A conditioning device 62 is disclosed. The conditioning device 62 may be a machining device for removing the fretting and/or to form the pin with a concentric shape. A device for applying plating 64 to the pin is also disclosed. In an exemplary embodiment, the plating device 64 is a plating bath where the pin 10, 30 is placed within the bath.

Those skilled in the art will readily recognize that the elements disclosed in FIG. 4 may be all operated by a computer processor 66 that is capable of managing the autonomous refurbishment of the pin 10, 30 through each apparatus, machine, or device, 60, 62, 64 to achieve a plated pin 10, 30 that can be used again in an engine, such as a locomotive engine. Furthermore, a device 68 may be provided to cover the area of the pin 10, 30 that should not be touched by the plating material when applied. This covering may include, but is not limited to, thermal tape and plugs to insure that the radius of the areas is free of the plating material.

Since the processor 66 may operate the present invention, those skilled in the art will readily recognize that the present invention may be automated, or autonomous in operation. Towards this end, persons skilled in the art will recognize that an apparatus, such as a computer, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk or other similar computer program product for use with a data processing system or computer, could include a storage medium and program means recorded thereon for directing the data processing system to facilitate the practice of the method of the invention. Such apparatus and articles of manufacture also fall within the spirit and scope of the invention.

Broadly speaking, a technical effect of an embodiment of the invention is a method, apparatus, and computer program that enables the removal of fretting from and the platting to parts of an engine, such as a locomotive diesel engine. To facilitate an understanding of the present invention, it is described above with reference to specific implementations thereof. The invention is described in the general context of computer-executable instructions, such as program modules, being executed by a computer. Generally, program modules include routines, programs, objects, components, data structures, etc., that perform particular tasks or implement particular abstract data types. For example, the software programs that underlie the invention can be coded in different languages, for use with different platforms. In the description above, examples of the invention may be implemented in the context of a web portal that employs a web browser. It will be appreciated, however, that the principles that underlie the embodiments of the invention can be implemented with other types of computer software technologies as well.

Moreover, those skilled in the art will appreciate that the embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote computer storage media including memory storage devices.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What we claim is:

1. A method for restoring at least one of a piston pin and an articulating pin after operating in an engine, the method comprising:
a. removing materials from the pin so that the pin has a concentric shape;
b. conditioning the pin to accept application of a new material; and
c. plating the outer diameter of the pin so as to restore the pin to near original dimensions.

2. The claim of 1 wherein conditioning the pin further comprises stress relieving the pin.

3. The claim of 1 wherein conditioning the pin further comprises vibratory honing the pin.

4. The claim of 1 wherein plating the outer diameter further comprises plating the outer diameter with nickel.

5. The claim of 1 further comprises hydrogen baking the pin after plating has been applied.

6. The claim of 1 wherein conditioning the pin further comprises covering an area on the pin so that plating does not occur in the covered area.

7. The claim of 1 further comprising inspecting the pin once the step of plating is complete to insure the pin has accepted the plating.

8. The claim of 6 further comprising uncovering the covered area once the step of plating is complete.

9. A computer software code for a computer for autonomously restoring at least one of a piston pin and an articulating pin after operating in an engine, the computer software code comprising:
a. a computer module for operating an instrument for removing materials from the pin so that the pin has a concentric shape;
b. a computer module for operating an instrument for conditioning the pin to accept application of a new material; and
c. a computer module for operating an instrument for plating the outer diameter of the pin so as to restore the pin to near original dimensions.

10. The computer program of claim 9 further comprises a computer module for operating an instrument for hydrogen baking the pin after plating has been applied.

11. The computer program of claim 9 wherein a computer module for operating an instrument for conditioning the pin further comprises a computer module at least one of stress relieving the pin, vibratory honing the pin, and covering an area of the pin so that plating does not occur in the covered area.

12. A system for restoring at least one of a piston pin and an articulating pin after operating in an engine, the system comprising:
a. a length determining device for determining a diameter of the rod;
b. a conditioning device for at least one of removing undesired material and providing the pin with a concentric shape;
c. a plating device for fixing a second material to the pin; and
d. wherein the pin with the fixed material restores the pin to an acceptable diameter for use within the engine.

13. The system of claim 12 wherein the conditioning device comprises a machining device.

14. The system of claim 13 wherein the machining device is used to eccentric the pin so as to remove material that has resulted in the pin no longer being concentric.

15. The system of claim 12 wherein the plating device comprises a plating bath.

16. The system of claim 12 wherein the material applied with the plating device is nickel.

17. The system of claim 12 further comprises a masking device to cover an area of the pin where plating should not be applied.

18. A pin for use as at least one of a piston pin and an articulating pin that is used in an engine, the pin comprising:
a. an inner core made of a pin that has previously operated within the engine; and
b. an outer cover applied to parts of the inner core that is able to within operating conditions of the engine.

19. The pin of claim 18 wherein the outer cover comprises nickel.

20. The pin of claim 18 wherein the outer cover restores the pin to at least one of an original concentric shape and an original dimension.

21. In an engine having at least one of a piston pin and an articulating pin that accumulates fretting after operating in the engine so that the pin is no longer concentric, a method for restoring an outer circumference of the pin to a concentric shape, the method comprising:
a. locating an offset axis on the pin;
b. rotating the pin about the offset axis so that a fretted area rotates at a distance further away from the offset axis than the rest of the pin; and
c. rotating the pin proximate a grinder so that only the fretted area contacts the grinder.
